(19) United States
(12) Patent Application Publication
(10) Pub. No.: US 2007/0200763 A1
(43) Pub. Date: Aug. 30, 2007

(54) Phased array antenna including flexible layers and associated methods

(75) Inventors: Bibb Bevis Allen, Palm Bay, FL (US); John W. Shipley, Sebastian, FL (US); Steven E. Wilson, Malabar, FL (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: Harris Corporation, Melbourne, FL (US)

(21) Appl. No.: 11/363,988

(22) Filed: Feb. 28, 2006

(51) Int. Cl. H01Q 1/38

(52) U.S. Cl. 343/700 MS; 343/879

(57) ABSTRACT

A phased array antenna may include a first flexible layer, in turn, including a plurality of phased array antenna elements. The phased array antenna may further include a second flexible layer including an electrically conductive material that serves as a ground plane for the phased array antenna elements. In addition, spacer members may be between the first and second flexible layers to permit movement thereof between a collapsed-together stowed position and a spaced-apart deployed position.

### FIELD OF THE INVENTION

The invention relates to the field of communications, and, more particularly, to antenna systems and related methods.

### BACKGROUND OF THE INVENTION

An antenna is typically used to capture electromagnetic energy to a receiver when used in a receive mode, and, conversely radiates electromagnetic energy from a transmitter when used in a transmit mode. Antennas are also commonly used in spaceborne systems that present special considerations. A spaceborne antenna is typically transported to space in a compacted or stowed position. Upon arrival of the satellite at its desired location in space, the antenna is moved to an expanded or deployed condition. The weight of a spaceborne antenna is also desirably kept to a minimum. In addition, the antenna itself and any deployment structure is also subject to considerable stress, particularly from acoustic energy, during liftoff.

One type of spaceborne antenna is an expandable reflector-type antenna including a conductive mesh layer that serves as the reflector. The mesh reduces the weight of the reflector-type antenna and permits it to be stowed compactly. U.S. Pat. No. 6,836,255 to Davis discloses a deployable hybrid parabolic reflector-type antenna system that includes a mesh-type parabolic reflector fed by a phased array antenna. U.S. Pat. No. 6,268,835 to Toland et al. discloses a deployable array of individual reflector-type antennas.

U.S. Pat. No. 4,896,165 to Koizumi discloses a deployable parabolic reflector antenna that includes a mesh-like flexible antenna member supported between tubular members by support cables. The antenna further includes additional cables used to tension the mesh into the desired shape. U.S. Pat. No. 6,411,255 to Roederer discloses a deployable reflector antenna that includes a plurality of mesh panels carrying an array of radiating elements. Applied Radar Inc. of North Kingstown, R.I., has produced a phased array antenna using a closed mesh textile fabric supporting the antenna components.

Unfortunately, despite developments in deployable antennas, and particularly, deployable phased array antennas, there still exists a need for further developments to provide compact stowage, light weight, ready deployment, and robustness for a phased array antenna.

### SUMMARY OF THE INVENTION

In view of the foregoing background, it is therefore an object of the invention to provide a phased array antenna that stows compactly, is lightweight, is robust, and that is readily deployed.

This and other objects, features, and advantages in accordance with the invention are provided by a phased array antenna that may include a first flexible layer comprising a plurality of phased array antenna elements, a second flexible layer comprising an electrically conductive material that serves as a ground plane, and a plurality of spacer members between the first and second flexible layers. The spacer members permit movement of the first and second layers between a collapsed-together stowed position and a spaced-apart deployed position. Accordingly, the phased array antenna may be lightweight, and may be readily stowed in a compact collapsed position and thereafter deployed.

At least one of the first and second flexible layers may comprise an open-mesh layer. The second flexible layer may comprise an electrically conductive open-mesh layer defining the ground plane. The electrically conductive open-mesh layer may comprise an open-mesh dielectric layer and a metal coating thereon, for example.

The second flexible layer may further comprise a plurality of processing modules connected to the plurality of phased array antenna elements and may be carried by the electrically conductive open-mesh layer on a side thereof opposite the plurality of spacer members. The second flexible layer may also comprise power supply wiring carried by the electrically conductive open-mesh layer and connected to the plurality of processing modules. The second flexible layer may further comprise a signal path network carried by the electrically conductive open-mesh layer and connected to the plurality of processing modules.

The first flexible layer may further comprise a dielectric open-mesh layer carrying the plurality of phased array antenna elements. Each of the plurality of phased array antenna elements may comprise an electrically conductive element, and each of the plurality of spacer members may comprise an elongate flexible member, for example.

At least some of the plurality of spacer members may comprise one or more signal conductors connected to a corresponding phased array antenna element. The plurality of spacer members may define a fixed constant spacing between the first and second flexible layers in some embodiments.

The first flexible layer may define a planar surface in the deployed position. In addition, the phased array antenna may further comprise a support structure connected to the first and second flexible layers for tensioning the first and second flexible layers in the deployed position.

A method aspect of the invention is directed to making a phased array antenna that may include forming a first flexible layer comprising a plurality of phased array antenna elements. The method may also include forming a second flexible layer comprising an electrically conductive material to serve as a ground plane for the plurality of phased array antenna elements. The method may further include forming a plurality of spacer members between the first and second flexible layers to permit movement thereof between a collapsed-together stowed position and a spaced-apart deployed position.

### BRIEF DESCRIPTION OF THE DRAWINGS

FIG. 1 is a schematic perspective view of a spacecraft and a phased array antenna in accordance with the invention.

FIG. 2 is an enlarged schematic perspective view of a portion of the first and second flexible layers of the phased array antenna of FIG. 1.

FIG. 3 is a schematic cross-sectional view of a single phased array element of the phased array antenna of FIG. 1.

FIG. 4 is a schematic cross-sectional view of the single phased array element of FIG. 3 when partially stowed.

FIG. 5 is a greatly enlarged cross-sectional view of a strand of the lower flexible layer of the antenna embodiment as shown in FIG. 4.

### DETAILED DESCRIPTION OF THE PREFERRED EMBODIMENTS

The invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

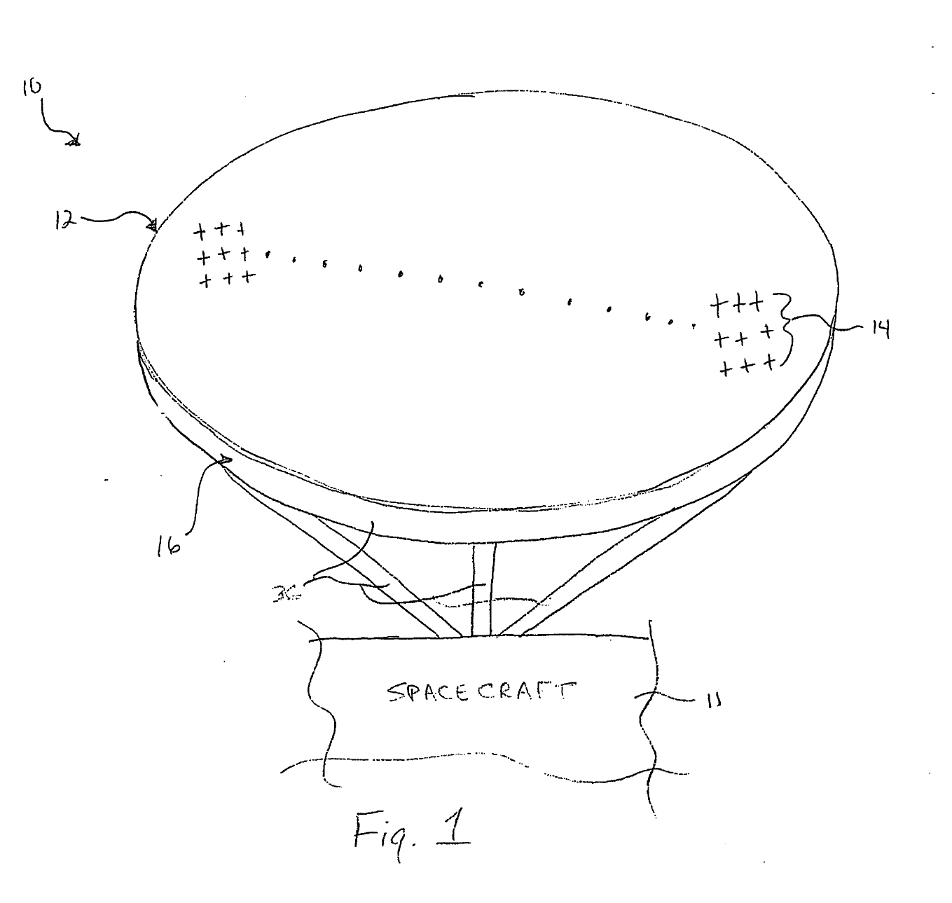

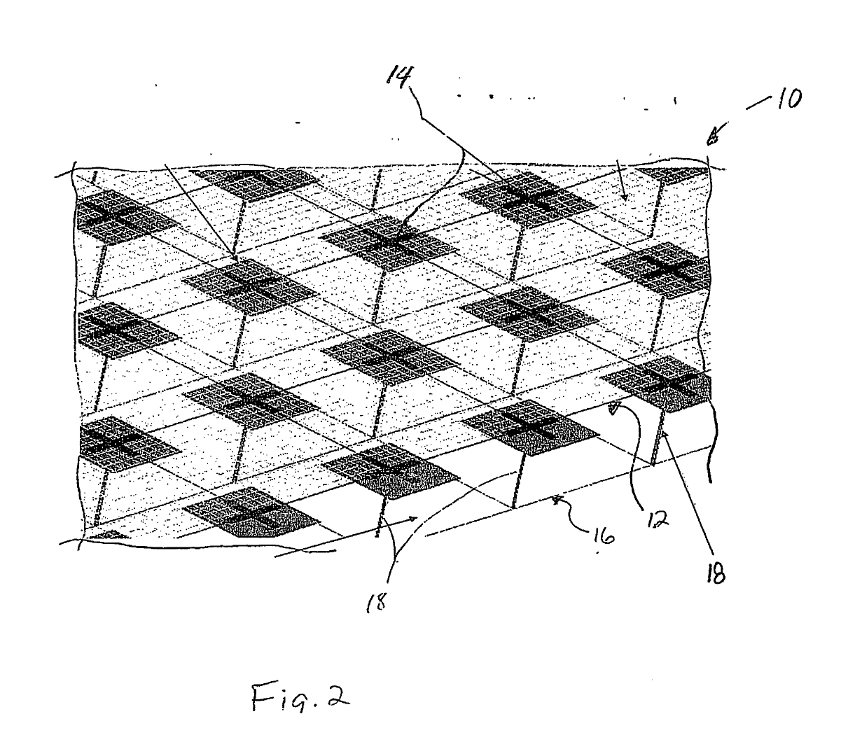

Referring initially to FIGS. 1 and 2, a phased array antenna 10 illustratively carried by a spacecraft 11 in accordance with the invention is first described. Of course, the phased array antenna 10 has other airborne and terrestrial applications as will be appreciated by those skilled in the art. The phased array antenna 10 illustratively includes a first flexible layer 12 comprising a plurality of phased array antenna elements 14. The phased array antenna 10 further includes a second flexible layer 16 comprising an electrically conductive material to serve as a ground plane for the plurality of phased array antenna elements 14. A plurality of spacer members 18 is between the first and second flexible layers 12, 16.

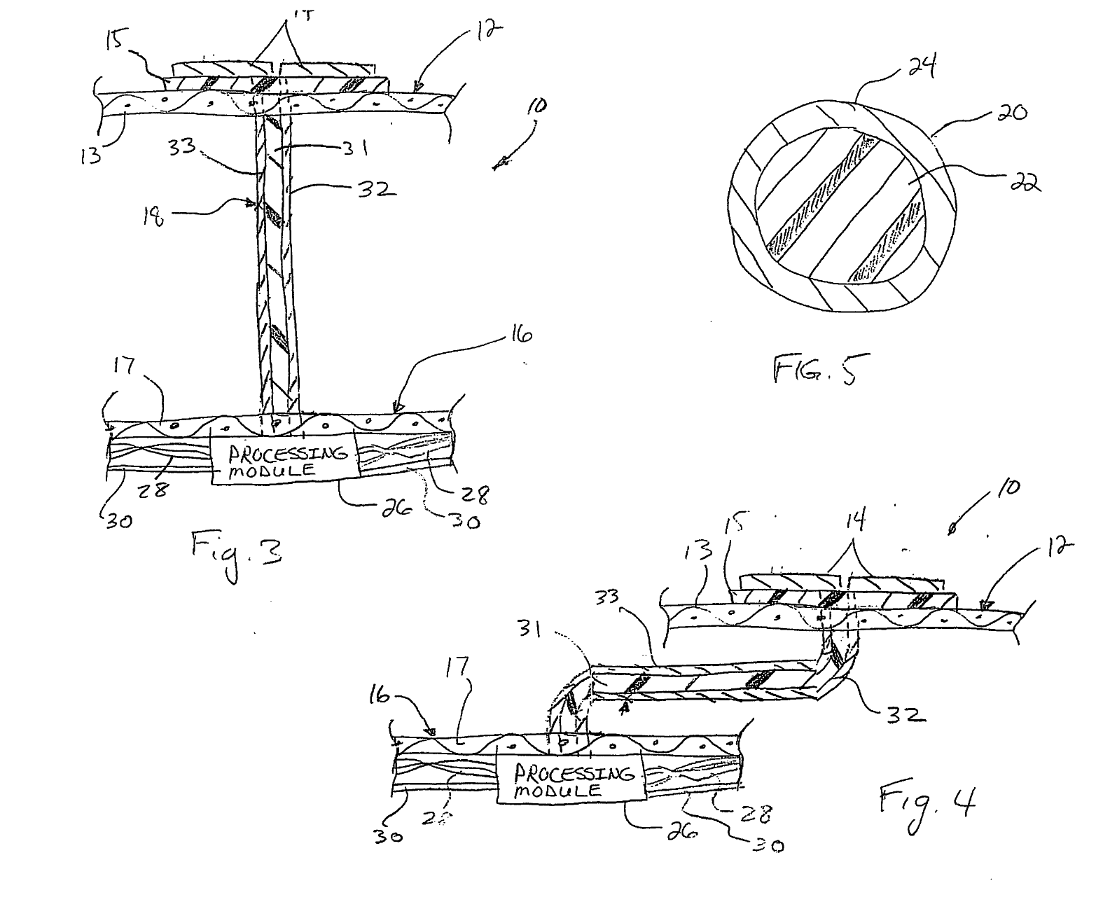

Referring now additionally to FIGS. 3 and 4, the plurality of spacer members 18 cooperate with the first and second flexible layers 12, 16 to permit movement thereof between a collapsed-together stowed position (FIG. 4) and a spaced-apart deployed position (FIG. 3). The collapsed-together stowed position may be achieved by rolling up and/or folding together the phased array antenna 10 to reduce its overall size. Accordingly, the phased array antenna 10 may be lightweight, rugged, and may stow compactly.

The first and second flexible layers 12, 16 may comprise textile filaments, for example. In addition, one or both of the first and second flexible layers 12, 16 may comprise open-mesh layers 13, 17 as shown in the illustrated embodiment. The open mesh layers 13, 17 may have a relatively wide spacing between adjacent strands of the open mesh. In alternative embodiments, the mesh may be more dense, that is, have smaller opening sizes, as will be appreciated by those of skill in the art. The open mesh configuration is in contrast to a closed mesh such as provided by a tightly woven textile fabric, for example. Of course, in some embodiments, the flexible layers could include a closed mesh as will be appreciated by those skilled in the art.

The second flexible layer 16 may comprise an electrically conductive open-mesh layer 17 defining the ground plane. As understood with additional reference to FIG. 5, a single filament or strand 20 of the electrically conductive open-mesh layer 17 may comprise a dielectric core 22 with a metal coating 24 thereon. In other embodiments, the second flexible layer 16 could be formed of electrically conductive filaments or strands.

With particular reference to FIGS. 3 and 4, the second flexible layer 16 further comprises a plurality of processing modules 26 connected to the plurality of phased array antenna elements 14 and carried by the electrically conductive open-mesh layer 17 on a side thereof opposite the plurality of spacer members 18. The plurality of processing modules 26 may comprise amplifiers, phase shifters, and the like for the control of the plurality of phased array antenna elements 14 as will be appreciated by those of skill in the art. In other embodiments, the processing could be performed remote from the array, or the processing modules could be provided at other locations.

The second flexible layer 16 also illustratively includes power supply wiring 28 carried by the electrically conductive open-mesh layer 17 and connected to the plurality of processing modules 26. The power supply wiring 28 could be integrated into the open-mesh layer 17 or carried by the back side as shown in the illustrated embodiment.

The second flexible layer 16 further comprises a signal path network illustratively provided by cables 30 carried by the electrically conductive open-mesh layer 17 and connected to the processing modules 26. The signal path network 30 may include wired connections, wireless connections, optical connections, or combinations thereof as will be appreciated by those of skill in the art.

The first flexible layer 12 comprises a dielectric open-mesh layer 13 carrying the plurality of phased array antenna elements 14 mounted on an optional supporting substrate 15. Each of the plurality of phased array antenna elements 14 may comprise electrically conductive layers in the form of a dipole or crossed-dipoles if dual polarization is desired. Of course, other antenna elements could also be provided.

Some or all of the spacer members 18 may include an elongate flexible member 31, such as in the form of a flexible circuit board. Moreover, some or all of the spacer members 18 may also comprise one or more signal conductors 32, 33 comprising traces on the flexible circuit board. The signal conductors 32, 33 may connect the antenna elements 14 to the processing modules 26.

Other configurations of the spacer members 18 may also be provided as will be appreciated by those skilled in the art. For example, in other embodiments, the spacer members 18 may be an elongate rigid member such as a rigid conductor, rigid non-conductor, and the like. The plurality of spacer members 18 may define a fixed constant spacing between the first and second flexible layers 12, 16, in other words, a parallel arrangement as will be appreciated by those of skill in the art. The first flexible layer 12 is also illustratively shown to define a planar surface (FIG. 1) in the deployed position. In other embodiments, the first flexible layer 12 may define a curved surface, for example, as will be appreciated by those of skill in the art.

The phased array antenna 10 further comprises a support structure 36 connected to the first and second flexible layers 12, 16 for tensioning the first and second flexible layers in the deployed position. The support structure 36 is schematically illustrated to comprise a hoop and supporting struts in FIG. 1. In other embodiments, the support structure 36 may comprise an open truss and/or may have a different shape. Further, the support structure 36 may comprise cords and ties, or ribs as will be appreciated by those of skill in the art.

A method aspect of the invention is directed to making a phased array antenna 10 that may include forming a first flexible layer 12 comprising a plurality of phased array antenna elements 14. The method may also include forming a second flexible layer 16 comprising an electrically conductive material to serve as a ground plane for the plurality of phased array antenna elements 14. The method may further include forming a plurality of spacer members 18 between the first and second flexible layers 12, 16 to permit movement thereof between a collapsed-together stowed position and a spaced-apart deployed position.

A third flexible layer (not shown) may be provided adjacent the first flexible layer 12 and above the plurality of phased array antenna elements 14. The third flexible layer may comprise, for example, a frequency selective material as will be appreciated by those of skill in the art.

The antenna structures disclosed herein may be considered as a microstrip antenna implementation as will be appreciated by those of skill in the art. Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that other modifications and embodiments are intended to be included within the scope of the appended claims.

That which is claimed is:

1. A phased array antenna comprising:
a first flexible layer comprising a plurality of phased array antenna elements;
a second flexible layer comprising an electrically conductive material to serve as a ground plane for said plurality of phased array antenna elements; and
a plurality of spacer members between said first and second flexible layers to permit movement thereof between a collapsed-together stowed position and a spaced-apart deployed position.

2. The phased array antenna according to claim 1 wherein at least one of said first and second flexible layers comprises an open-mesh layer.

3. The phased array antenna according to claim 1 wherein said second flexible layer comprises an electrically conductive open-mesh layer defining the ground plane.

4. The phased array antenna according to claim 3 wherein said electrically conductive open-mesh layer comprises an open-mesh dielectric layer and a metal coating thereon.

5. The phased array antenna according to claim 3 wherein said second flexible layer further comprises a plurality of processing modules connected to said plurality of phased array antenna elements and carried by said electrically conductive open-mesh layer on a side thereof opposite said plurality of spacer members.

6. The phased array antenna according to claim 5 wherein said second flexible layer further comprises power supply wiring carried by said electrically conductive open-mesh layer and connected to said plurality of processing modules.

7. The phased array antenna according to claim 5 wherein said second flexible layer further comprises a signal path network carried by said electrically conductive open-mesh layer and connected to said plurality of processing modules.

8. The phased array antenna according to claim 1 wherein said first flexible layer further comprises a dielectric open-mesh layer carrying said plurality of phased array antenna elements.

9. The phased array antenna according to claim 1 wherein each of said plurality of phased array antenna elements comprises an electrically conductive element.

10. The phased array antenna according to claim 1 wherein each of said plurality of spacer members comprises an elongate flexible member.

11. The phased array antenna according to claim 1 wherein at least some of said plurality of spacer members comprise at least one signal conductor connected to a corresponding phased array antenna element.

12. The phased array antenna according to claim 1 wherein said plurality of spacer members define a fixed constant spacing between said first and second flexible layers.

13. The phased array antenna according to claim 1 wherein said first flexible layer defines a planar surface in the deployed position.

14. The phased array antenna according to claim 1 further comprising a support structure connected to said first and second flexible layers for tensioning said first and second flexible layers in the deployed position.

15. A phased array antenna comprising:
a first flexible layer comprising an open-mesh dielectric layer and a plurality of phased array antenna elements carried thereby;
a second flexible layer comprising an open-mesh electrically conductive layer to serve as a ground plane for said plurality of phased array antenna elements; and
a plurality of spacer members between said first and second flexible layers to permit movement thereof between a collapsed-together stowed position and a spaced-apart deployed position.

16. The phased array antenna according to claim 15 wherein said electrically conductive open-mesh layer comprises another open-mesh dielectric layer and a metal coating thereon.

17. The phased array antenna according to claim 15 wherein said second flexible layer further comprises a plurality of processing modules connected to said plurality of phased array antenna elements and carried by said electrically conductive open-mesh layer on a side thereof opposite said plurality of spacer members.

18. The phased array antenna according to claim 15 wherein said second flexible layer further comprises:
power supply wiring carried by said electrically conductive open-mesh layer and connected to said plurality of processing modules; and
a signal path network carried by said electrically conductive open-mesh layer and connected to said plurality of processing modules.

19. The phased array antenna according to claim 15 wherein each of said plurality of spacer members comprises an elongate flexible member.

20. The phased array antenna according to claim 15 wherein at least some of said plurality of spacer members comprises at least one signal conductor connected to a corresponding phased array antenna element.

21. The phased array antenna according to claim 1 further comprising a support structure connected to said first and second flexible layers for tensioning said first and second flexible layers in the deployed position.

22. A method of making a phased array antenna comprising:
forming a first flexible layer comprising a plurality of phased array antenna elements;
forming a second flexible layer comprising an electrically conductive material to serve as a ground plane for the plurality of phased array antenna elements; and
forming a plurality of spacer members between the first and second flexible layers to permit movement thereof between a collapsed-together stowed position and a spaced-apart deployed position.

23. The method according to claim 22 wherein at least one of the first and second flexible layer comprises an open-mesh layer.

24. The method according to claim 22 wherein the second flexible layer comprises an electrically conductive open-mesh layer defining the ground plane.

25. The method according to claim 24 wherein the electrically conductive open-mesh layer comprises an open-mesh dielectric layer and a metal coating thereon.

26. The method according to claim 24 wherein the second flexible layer further comprises a plurality of processing modules connected to the plurality of phased array antenna elements and carried by the electrically conductive open-mesh layer on a side thereof opposite the plurality of spacer members.

27. The method according to claim 26 wherein the second flexible layer further comprises a signal path network carried by the electrically conductive open-mesh layer and connected to the plurality of processing modules.

28. The method according to claim 22 wherein the first flexible layer further comprises a dielectric open-mesh layer carrying the plurality of phased array antenna elements.

29. The method according to claim 22 wherein at least some of the plurality of spacer members comprises at least one signal conductor connected to a corresponding phased array antenna element.

30. The method according to claim 22 wherein the plurality of spacer members define a fixed constant spacing between the first and second flexible layers.
